(19) United States
(12) Patent Application Publication
(10) Pub. No.: US 2007/0251603 A1
(43) Pub. Date: Nov. 1, 2007

(54) Novel surface aesthetics employing magnetic particles

(76) Inventor: Barry D. Olson, Williamsville, NY (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/412,178

(22) Filed: Apr. 26, 2006

(51) Int. Cl. H01F 41/16

(52) U.S. Cl. 148/104

(57) ABSTRACT

Polymeric or polymerizable material with oriented magnetic anisotropic particles is subjected to magnetic fields that reorient the magnetic particles. The result is an aesthetic patterned appearance.

### BACKGROUND OF THE INVENTION

1. Field of Invention

This invention relates to a process for producing a decorative surfacing material by selective orientation of decorative fillers by magnetic means.

2. Description of the Related Art

The preferred use for the process of this invention is the production of a decorative solid surface material. As employed herein, a solid surface material is understood in its normal meaning and represents a uniform, non-gel coated, non-porous, three dimensional solid material containing polymer resin and particulate filler, such material being particularly useful in the building trades for kitchen countertops, sinks, wall coverings, and furniture surfacing wherein both functionality and an attractive appearance are necessary. A well-known example of a solid surface material is Corian® produced by E. I. DuPont de Nemours and Company. A number of design aesthetics are heretofore known in solid surface materials, such as granite and marble, but they have a mostly two-dimensional appearance.

Most solid surface materials are manufactured by thermoset processes, such as sheet casting, cell casting, injection molding, or bulk molding. The decorative qualities of such products are greatly enhanced by incorporating pigments and colored particles such that the composite resembles natural stone. The range of patterns commercially available are constrained by the intermediates and processes currently used in the manufacturing of such materials.

Solid surface materials in their various applications serve both functional and decorative purposes. The incorporation of various attractive and/or unique decorative patterns into solid surface materials enhances its utility. Such patterns constitute intrinsically useful properties, which differentiate one product from another. The same principle applies to naturally occurring materials such as wood, marble, and granite whose utility, for example in furniture construction, is enhanced by certain naturally occurring patterns, e.g., grain, color variations, veins, strata, inclusions, and others. Commercially manufactured solid surface materials often incorporate decorative patterns intended to imitate or resemble naturally occurring patterns in granite or marble. However, due to limitations of feasibility and/or practicality, certain decorative patterns and/or categories of decorative patterns have not previously been incorporated in solid surface materials.

Decorative patterns that have been previously achieved in traditional solid surface manufacturing typically employ one of three methods:
(i) Monochromatic or polychromatic pieces of a pre-existing solid surface product are mechanically ground to produce irregularly shaped macroscopic particles, which are then combined with other ingredients in an uncured solid surface casting composition. Commonly employed macroscopic decorative particles known to the industry as “crunchies” are various filled and unfilled, pigmented or dyed, insoluble or crosslinked chips of polymers. Curing the casting composition during casting or molding produces a solid surface material in which colored inclusions of irregular shapes and sizes are surrounded by, and embedded in a continuous matrix of different color.
(ii) Casting a first and second curable compositions wherein the second composition is of a different color than the first composition, and is added in such a way that the two only intermix to a limited degree. In the resulting solid surface material, the different colored domains have smooth shapes and are separated by regions with continuous color variation.
(iii) Fabricating different colored solid surface products by cutting or machining into various shapes, which are then joined by means of adhesive to create multi-colored inlayed patterns or designs.

Using these traditional methods, it is required to mix materials of different colors or appearances to form decorative patterns. They do not produce certain categories of decorative patterns not dependent on combinations of different colors.

A new class of aesthetic for solid surface materials is disclosed in U.S. Pat. No. 6,702,967 to Overholt et al which discloses a process for making a decorative surfacing material having a pattern by preparing a curable composition with orientable anisotropic particles, forming numerous fragments of the composition, and reforming the fragments into a cohesive mass with at least some of the fragments having the oriented particles in different orientations.

### SUMMARY OF THE INVENTION

The invention is a process for forming a decorative pattern in a surface of a solid surface material containing magnetic anisotropic particles comprising the steps of orienting at least a majority of the magnetic anisotropic particle in a flowable solid surface material, inducing a magnetic field in a portion of surface areas of the flowable solid surface material to change the orientation of magnetic particles in the magnetic field, and solidifying the flowable solid surface material.

### DRAWINGS

These and other features, aspects, and advantages of the present invention will become better understood with reference to the following description, append claims, and accompanying drawings where

FIG. 1 is cross-section of a sheet of material with oriented anisotropic particulate filler.

FIG. 2 is a cross-section of a sheet of material with regions of reoriented anisotropic particulate filler.

FIG. 3 is an illustration of the pattern created when traversing a composition containing anisotropic particulate filler that is magnetic in character with a magnetic field.

### DETAILED DESCRIPTION OF THE PREFERRED EMBODIMENTS

The present invention is a process for forming a decorative pattern in solid surface materials with magnetic anisotropic particles by orienting the anisotropic particulate filler. The magnetic anisotropic particulate filler in an uncured solid surface composition may be oriented by various means wherein at least some of the orientable particles are in a common orientation and subsequently reorienting, by various means, at least some of the oriented magnetic anisotropic particles (i.e., flakes) in specific regions to form a decorative pattern in solid surface materials. Another embodiment of the invention comprises a generally unoriented filler in the uncured solid surface composition and subsequently orienting, by various means, at least some of the unoriented magnetic anisotropic particles (i.e., flakes) in specific regions to form a decorative pattern. The pattern is created by differences in anisotropic particle orientation between adjacent regions within the solid surface material. The process will create an aesthetic three-dimensional appearance in the solid surface material by the way ambient light differentially interacts with the adjacent regions due to particle orientation.

Solid surface compositions useful in the present invention are not specifically limited as long as they are flowable under process conditions and can be formed into a solid surface material. The polymerizable composition may be a casting syrup as disclosed in U.S. Pat. No. 3,474,081 to Bosworth, and cast on a moving belt as disclosed in U.S. Pat. No. 3,528,131 to Duggins. In another embodiment of the invention, the polymerizable compositions may be made by a process in which compression molding thermosettable formulations are made and processed as described in Weberg et al, in U.S. Pat. No. 6,203,911 and the compression molding compound is put through an extrusion process step. Solid surface formulations could also include various thermoplastic resins capable of compression molding. In a further embodiment of the invention, the polymerizable composition may be made and extruded according to the disclosure of Beauchemin et al in U.S. Pat. No. 6,476,111. In all embodiments, orientable magnetic anisotropic aesthetic-enhancement particles are included in the polymerizable compositions, as described hereinafter. Anisotropic pigments, reflective particles, fibers, films, and finely divided solids (or dyes) may be used as the aesthetic-enhancement particles to highlight orientation effects. By controlling the amount of enhancement particles, and the shape and size of the reoriented regions, the translucency of the resulting solid surface material can be manipulated to give a desired aesthetic. Different colors, reflectivity, and translucency can be achieved by combining different amounts of enhancement particles, fillers, and colorants, and the degree to which the anisotropic filler particles are reoriented.

Magnetic anisotropic particulate fillers useful in the present invention are not specifically limited as long as they are magnetic in character, and have an aspect ratio that is sufficiently high to promote particle orientation during material processing and have an appearance that changes relative to the orientation to the material and the observer. Preferred magnetic anisotropic particulate fillers include materials that have an aspect ratio that is sufficiently high to promote particle orientation during material processing and have an appearance that changes relative to the orientation to the material and the observer. The aspect ratios of suitable enhancement particles cover a broad range, e.g. metallic flakes (20-100), mica (10-70), metallized glass fiber (3-25), metallized aramid fiber (100-500). These visual effects may be due to angle dependent reflectivity, angle dependent color absorption/reflection, or visible shape. These magnetic particles may be plate-like, fibers, or ribbons. The aspect ratio is the ratio of the greatest length of a particle to its thickness. Generally the aspect ratio will be at least 3, and more generally at least 20. Plate-like materials have two dimensions significantly larger than the third dimension. Examples of plate-like materials include, but are not limited to: mica, synthetic mica, metal flakes, alumina, synthetic materials such as ultra-thin, multi-layer interference flakes (e.g., Chromaflair® from Flex Products). In many cases, the surfaces of the plate-like substrate are coated with various metal oxides or pigments to control color and light interference effects, and add magnetic properties. Some materials appear to be different colors at different angles. Metal flakes with magnetic properties are found to be especially useful. Exemplary metal flakes for magnetic reorientation include steel, stainless steel, nickel, and combinations thereof.

Metal-coated fibers have one dimension that is significantly larger than the other two dimensions. Examples of fibers include, metal, polymer, carbon, glass, and ceramic. Ribbons have one dimension that is significantly larger than the other two, but the second dimension is noticeably larger than the third. Examples of ribbons would include metals and polymer films.

Optionally, the polymeric compositions may include particulate or fibrous fillers that are not isotropic, nor magnetic, nor aesthetic. In general, fillers increase the hardness, stiffness, or strength of the final article relative to the pure polymer or combination of pure polymers. It will be understood, that in addition, the filler can provide other attributes to the final article. For example, it can provide other functional properties, such as flame retardation, or it may serve a decorative purpose and modify the aesthetic. Some representative fillers include alumina, alumina trihydrate (ATH), alumina monohydrate, aluminum hydroxide, aluminum oxide, aluminum sulfate, aluminum phosphate, aluminum silicate, Bayer hydrate, borosilicates, calcium sulfate, calcium silicate, calcium phosphate, calcium carbonate, calcium hydroxide, calcium oxide, apatite, glass bubbles, glass microspheres, glass fibers, glass beads, glass flakes, glass powder, glass spheres, barium carbonate, barium hydroxide, barium oxide, barium sulfate, barium phosphate, barium silicate, magnesium sulfate, magnesium silicate, magnesium phosphate, magnesium hydroxide, magnesium oxide, kaolin, montmorillonite, bentonite, pyrophyllite, mica, gypsum, silica (including sand), ceramic microspheres, ceramic particles, ceramic whiskers, powder talc, titanium dioxide, diatomaceous earth, wood flour, borax, or combinations thereof. Furthermore, the fillers can be optionally coated with sizing agents, for example, silane (meth)acrylate which is commercially available from OSI Specialties (Friendly, W. Va.) as Silane 8 Methacrylate A-174. The filler is present in the form of small particles, with an average particle size in the range of from about 5-500 microns, and can be present in amounts of up to 65% by weight of the polymerizable composition.

The nature of the filler particles, in particular, the refractive index, has a pronounced effect on the aesthetics of the final article. When the refractive index of the filler is closely matched to that of the polymerizable component, the resulting final article has a translucent appearance. As the refractive index deviates from that of the polymerizable component, the resulting appearance is more opaque. ATH is often a preferred filler for poly(methylmethacrylate) (PMMA) systems because the index of refraction of ATH is close to that of PMMA. Of particular interest are fillers with particle size between 10 microns and 100 microns. Alumina (Al₂O₃) improves resistance to marring. Fibers (e.g., glass, nylon, aramid, and carbon fibers) improve mechanical properties. Examples of some functional fillers are antioxidants (such as ternary or aromatic amines, Irganox® (Octadecyl 3,5-Di-(tert)-butyl-4-hydroxyhydrocinnamate) supplied by Ciba Specialty Chemicals Corp., and sodium hypophosphites, flame retardants (such as halogenated hydrocarbons, mineral carbonates, hydrated minerals, and antimony oxide), UV stabilizers (such as Tinuvin® supplied by Ciba Geigy), stain-resistant agents such as Teflon®, stearic acid, and zinc stearate, or combinations thereof.

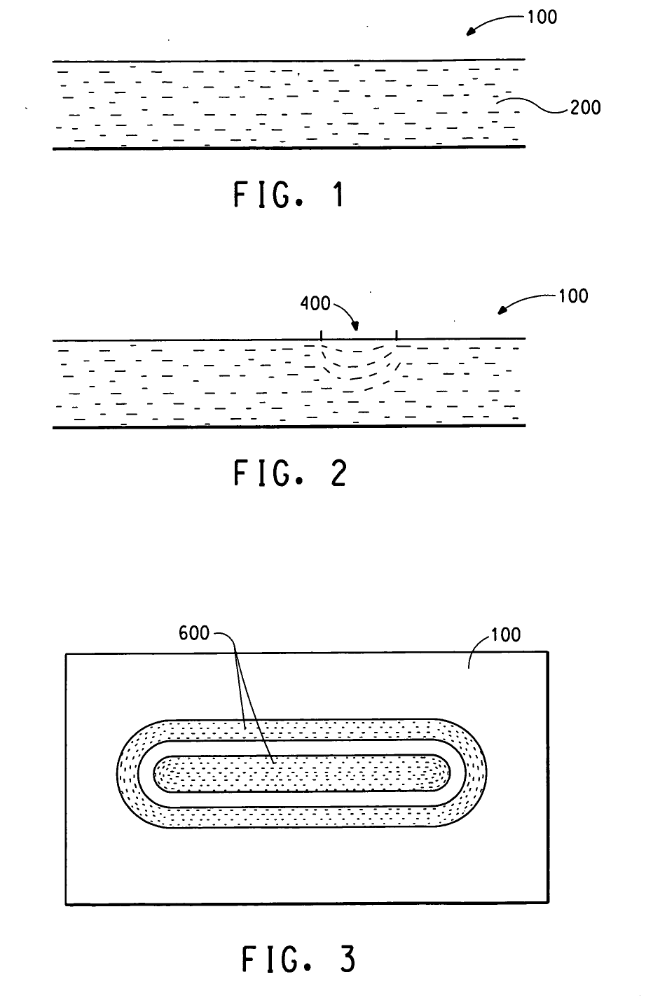

In carrying out the process of this invention, the orientation of the anisotropic particulate fillers may be done by taking advantage of the tendency of the particles to align themselves during laminar flow of the polymerizable matrix, as shown schematically in FIG. 1 wherein the oriented anisotropic particles (200) are shown generally parallel to the surface of a sheet (100). The laminar flow may be created by a number of process methods, depending on the rheological nature of the polymerizable composition. Flowable compositions may have the anisotropic particulate fillers oriented by casting on a moving belt, with optional employment of a doctor blade. Extrudable uncured solid surface molding compositions may employ extrusion through a die plate, with no limitations on the die geometry. Calender rolls may be used as the primary means of anisotropic particulate filler orientation, or added as an additional. The additional calendering step may be for the purpose of orienting the anisotropic particulate filler or may be for any other purpose, such as gauging the thickness of the material or adding a texture to the surface. In general at least 70% of the anisotropic particles, and more generally, at least 90% have the same orientation.

An aesthetic is created in the uncured solid surface composition by selective reorientation of the anisotropic particles. The reoriented particles do not have the same orientation as the bulk of the material after selective reorientation, which results in the region of the reorientation (400) appearing visually different as shown in FIG. 2. The actual method of selected reorientation can vary depending on the nature of the uncured solid surface composition and the desired aesthetic. The magnetic anisotropic particles have magnetic properties and are reoriented by traversing the uncured solid surface composition with magnetic fields.

The strength of the magnetic field is not critical provided the strength is sufficient to disrupt or change filler orientation in a localized volume of the surface. For purposes of illustration, a magnetic field of 35 gauss or less is suitable when applied over an extended time during the casting cure. A magnetic field of 250 gauss or more is typically used for short exposure times, including exposures of less than one second. Pattern orientation through the full thickness of a ½-inch thick casting using approximate one-second exposure is produced with larger magnetic fields with mid thickness field strengths of approximately 250 gauss.

The uncured solid surface composition may optionally be textured after the reorientation of the anisotropic particles. The uncured solid surface composition may be flattened to give a smooth texture, or have an aesthetic or functional texture added. A preferred means of texturing is by calender roll.

After any surface flattening or texturing, the uncured composition is solidified. Solidifying of the polymerizable composition after the reorientation of the anisotropic particles is done according to what polymer system is used. Most solid surface materials manufactured by thermoset processes, such as sheet casting, cell casting, injection molding, or bulk molding will use cure agents that when thermally activated will generate free radicals which then initiate the desired polymerization reactions. Either a chemically-activated thermal initiation or a purely temperature-driven thermal initiation to cure the acrylic polymerizable fraction may be employed herein. Both cure systems are well known in the art. Solidifying of thermoplastic embodiments of the invention, such as extruded thermoplastics, is accomplished by allowing the composition to cool below the glass transition temperature.

The following examples are included as representative of the embodiments of the present invention. The percentages are by weight, and the temperatures are in centigrade, unless otherwise noted.

### EXAMPLES

### Example 1

The following ingredients were weighed out and mixed:

| | | |
|---|---|---|
| 620 | gm | Alumina Trihydrate (ATM) |
| 318.13 | gm | Sirup (24% PMMA in MMA) |
| 39.58 | gm | MMA Monomer |
| 3.03 | gm | Trimethylol propane trimethacrylate (TRIM) |
| 8.49 | gm | PMA 25 paste (t-butylperoxy maleic acid) |
| 1.56 | gm | Dioctyl sodium sulfosuccinate |
| 0.68 | gm | 85% phosphated hydroxyethylmethacrylate in |
| | | butyl methacrylate |
| 9.96 | gm | stainless steel flake with magnetic |
| | | characteristics |

at a temperature of 28 degrees C. After mixing for 1 minute, 0.91 grams of distilled water was added to the mixture. The mixture was then evacuated under vacuum (24-25 in Hg) using a pump and a suitable condensing vapor trap. After mixing and evacuating for approximately 3 minutes, 2.58 grams of calcium hydroxide slurry (34% in syrup) and 1.33 grams of ethylene glycol dimercaptoacetate were added using syringes. After 45 seconds of additional mixing and evacuation, the mixture was poured into a container of square design to form a layer of approximately 0.5-inch thickness. The container had a 0.040-inch thick metal bottom made of AISI 301 stainless steel that had been demagnetized prior to the pour. It took approximately 20 seconds to transfer the mixed material from the mixer and pour it into the container.

The casting was then traversed with a magnetic field, creating a linear pattern. The magnetic field was created with two electromagnets with 0.5-inch diameter by 1.27-inch length inner cores made of 1215 steel. The electromagnet coils consisted of 4,000 turns, a coil winding density of approximately 3200 turns/inch, and a coil resistance of 150 ohms. The coil outer diameter was approximately 1 and 5/16-inches. The centerlines of the cylindrical electromagnets were aligned and the ends of the cores were spaced 0.060-inches from the bottom of the casting container and from the top of the poured casting. The electromagnet coils were wired with opposite polarity and powered with 0.5 amperes of direct current. The electromagnets were positioned around the casting, the power was turned on, and the electromagnets were traversed across the casting at a speed of approximately 4.6 inches per second. The power was turned on approximately 120 seconds after the calcium hydroxide slurry and ethylene glycol dimercaptoacetate were injected. The electromagnet motion was stopped and the current was turned off at the end of the linear traverse. The electromagnets were then moved away from the container, insulation was placed on top of the casting and underneath the casting container, and the casting was allowed to cure.

The electromagnet traverse created a linear pattern of darkened bands relative to the lighter background of the casting. The pattern consists of an approximate 0.4-inch wide darkened line aligned with the centerline of the electromagnet traverse. Two background colored lines approximately 0.15-inches wide parallel the 0.4-inch darkened centerline. Two more darkened colored lines approximately 0.2-inches wide parallel the 0.15-inches lines. The patterns around both end points of the electromagnet traverse are semicircular. The semicircular patterns have darkened centers with perimeter semicircular rings around the end centers; background colored inner rings of 0.15-inch radial width and darkened outer rings of 0.2-inch radial width. Although the boundaries between colors are fuzzy or less distinct than shown in FIG. 3, the drawing shows the general pattern created.

### Example 2

The metal-bottomed container described in Example 1 was demagnetized and subsequently magnetized by using the electromagnet system and motion-traverse sequence described in Example 1. A casting mixture was weighed out, mixed, and evacuated in the same manner and sequence as done in Example 1. The mixture was poured into this magnetized container approximately 20 seconds after mixing was stopped, analogous to Example 1. Insulation was placed on top of the casting and underneath the casting container and the casting was allowed to cure.

The magnetic field imparted to the container was sufficient to produce the same linear particle reorientation pattern in the casting as described in Example 1.

What is claimed is:

1. A process for forming a decorative pattern in a surface of a solid surface material containing anisotropic particles having magnetic properties comprising the steps of:
(a) orienting at least a majority of the magnetic anisotropic particle in a flowable solid surface material,
(b) inducing a magnetic field in a portion of surface areas of the flowable solid surface material to change the orientation of the particles having magnetic properties in the magnetic field, and
(c) solidifying the flowable solid surface material.

2. The process of claim 1 wherein the solid surface material is comprised of acrylic resin.

3. The process of claim 1 wherein the solid surface material is comprised of polyester resin.

4. The process of claim 1 wherein the aspect ratio of the anisotropic particles have an aspect ration of at least 3.

5. The process of claim 1 wherein the anisotropic particles having magnetic properties are selected from steel, stainless steel, nickel, and combinations thereof.

6. A process for forming a decorative pattern in a surface of a solid surface material containing magnetic anisotropic particles comprising the steps of:
(a) orienting at least a majority of the magnetic anisotropic particle in a flowable solid surface material,
(b) inducing a magnetic field in a portion of surface areas of the flowable solid surface material to change the orientation of magnetic particles in the magnetic field,
(c) texturing the surface of the flowable solid surface, and
(d) solidifying the flowable solid surface material.
